(19) United States
(12) Patent Application Publication
(10) Pub. No.: US 2007/0150951 A1
(43) Pub. Date: Jun. 28, 2007

(54) Methods, communication networks, and computer program products for managing application(s) on a vulnerable network element due to an untrustworthy network element by sending a command to an application to reduce the vulnerability of the network element

(76) Inventors: Jeffrey Aaron, Atlanta, GA (US); Edgar Shrum JR., Smyrna, GA (US)

Correspondence Address: MYERS BIGEL SIBLEY & SAJOVEC, P.A., P.O. BOX 37428, RALEIGH, NC, 27627, US

(21) Appl. No.: 11/315,917

(22) Filed: Dec. 22, 2005

(51) Int. Cl. G06F 12/14

(52) U.S. Cl. 726/22

(57) ABSTRACT

A communication network is operated by determining whether a network element can be trusted, determining at least one vulnerable network element based on a determination that the network element cannot be trusted, selecting a controllable application on the at least one vulnerable network element, and sending a command to the controllable application to reduce the vulnerability of the at least one vulnerable network element.

### FIELD OF THE INVENTION

The present invention relates to communication networks and methods of operating the same, and, more particularly, to methods, systems, and computer program products for managing application(s) on vulnerable network elements due to untrustworthy network elements.

### BACKGROUND OF THE INVENTION

Entities, such as gateways, routers, switches, servers, controllers, and/or balancers, in the path(s) of a communication network can be attacked and/or compromised, which may allow one or more of those entities to be used by the attacker or hacker for undesirable purposes. Other entities in the network may then be vulnerable to attack from the now compromised entity. In some cases, applications resident on those other entities might be able to provide some amount of protection, but they are not normally configured to do so as this may be costly and may adversely affect normal activities on the network. Moreover, there may not be a mechanism by which to notify one or more applications that a network element has been compromised so that the application(s) can take appropriate defensive action.

### SUMMARY OF THE INVENTION

According to some embodiments of the present invention, a communication network is operated by determining whether a first network element can be trusted, determining at least one vulnerable network element based on a determination that the first network element cannot be trusted, selecting a controllable application on the at least one vulnerable network element, and sending a command to the controllable application to reduce the vulnerability of the at least one vulnerable network element.

In other embodiments, determining whether a network element can be trusted comprises generating a first hash value based on data associated with the network element, generating a second hash value based on the data associated with the network element, and comparing the first hash value with the second hash value to determine whether the network element can be trusted.

In still other embodiments, generating the first hash value and generating the second hash value comprise generating the first hash value and the second hash value responsive to at least one of an expiration of a timer, a packet count associated with the network element, an event associated with then network element, and a hash generation command.

In still other embodiments, comparing the first hash value with the second hash value to determine whether the network element can be trusted comprises comparing the first hash value with the second hash value to determine a degree of trust for the network element.

In still other embodiments, determining the at least one vulnerable network element comprises determining the at least one vulnerable network element using rules that are based on the degree of trust for the network element.

In still other embodiments, potential untrustable network elements are associated with potential vulnerable network elements in the communication network. Potential controllable applications are associated with the potential vulnerable network elements, and controllable application parameters are identified that are associated with the controllable applications.

In still other embodiments, determining the at least one vulnerable network element based on the determination that the network element cannot be trusted comprises selecting the at least one vulnerable network element from at least one potential vulnerable network element associated with the network element. Furthermore, selecting the controllable application on the at least one vulnerable network element comprises selecting the controllable application as being associated with the at least one vulnerable network element.

In still other embodiments, selecting the controllable application comprises selecting the controllable application based on a degree of vulnerability associated with the at least one vulnerable network element and/or a priority associated with the controllable application.

In still other embodiments, the controllable application comprises a firewall application, an anti-virus application, a spy-ware application, an operating system, an email client, an instant messaging client, a calendaring client, a peer-to-peer communication client, a file manager application, a type manager application, and/or a gaming application.

In still other embodiments, sending the command to the controllable application comprises selecting the command based on defined rules for reducing the vulnerability of the at least one vulnerable network element, selecting at least one parameter identified as being associated with the controllable application and sending the command along with the selected at least one parameter to the controllable application.

In still other embodiments, the at least one parameter comprises an assignable network zone parameter, a traffic filtering parameter, a network service request parameter; a data transport parameter, a network element configuration parameter, a storage parameter, a security parameter, a file/data sharing parameter, an anti-virus parameter, an anti spy-ware parameter, a traffic exclusion parameter, a segregation of data and/or application parameter, a gaming parameter, a bandwidth parameter, a privacy parameter, a file management parameter, a type management parameter, and/or a spam filtering parameter.

In still other embodiments, sending the command to the controllable application comprises sending the command to the controllable application via a control client on the at least one vulnerable network element.

In still other embodiments, the at least one vulnerable network element is verified that it can be trusted.

In still other embodiments, execution of the command on the at least one vulnerable network element is monitored and an alert is generated if an error results from execution of the command.

Other systems, methods, and/or computer program products according to embodiments of the invention will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE DRAWINGS

Other features of the present invention will be more readily understood from the following detailed description of exemplary embodiments thereof when read in conjunction with the accompanying drawings, in which:

FIG. 1 is a block diagram that illustrates a communication network in accordance with some embodiments of the present invention; and

FIG. 2 is a flowchart that illustrates operations for managing application(s) on a vulnerable network element due to an untrustworthy network element by sending a command to an application to reduce the vulnerability of the network element in accordance with some embodiments of the present invention.

### DETAILED DESCRIPTION OF EXEMPLARY EMBODIMENTS

While the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention as defined by the claims. Like reference numbers signify like elements throughout the description of the figures.

As used herein, the singular forms “a,” “an,” and “the” are intended to include the plural forms as well, unless expressly stated otherwise. It will be further understood that the terms “includes,” “comprises,” “including,” and/or “comprising,” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations of one or more of the associated listed items.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The present invention may be embodied as systems, methods, and/or computer program products. Accordingly, the present invention may be embodied in hardware and/or in software (including firmware, resident software, micro-code, etc.). Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

The present invention is described herein with reference to flowchart and/or block diagram illustrations of methods, systems, and computer program products in accordance with exemplary embodiments of the invention. It will be understood that each block of the flowchart and/or block diagram illustrations, and combinations of blocks in the flowchart and/or block diagram illustrations, may be implemented by computer program instructions and/or hardware operations. These computer program instructions may be provided to a processor of a general purpose computer, a special purpose computer, or other programmable data processing apparatus to produce a machine, such that the instructions, which execute via the processor of the computer or other programmable data processing apparatus, create means for implementing the functions specified in the flowchart and/or block diagram block or blocks.

These computer program instructions may also be stored in a computer usable or computer-readable memory that may direct a computer or other programmable data processing apparatus to function in a particular manner, such that the instructions stored in the computer usable or computer-readable memory produce an article of manufacture including instructions that implement the function specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart and/or block diagram block or blocks.

In some embodiments of the present invention, a determination can be made whether a network element in a communication path can be trusted and/or to what degree the network element can be trusted. Based on this determination, a separate determination can be made to identify potential network elements that may be vulnerable to attack or degradation of service, for example, due to the presence of one or more untrustworthy elements. An application may be identified on a vulnerable network element for which a command may be sent to reduce the vulnerability of the network element. The results of the command may be monitored to ensure that the command was effective.

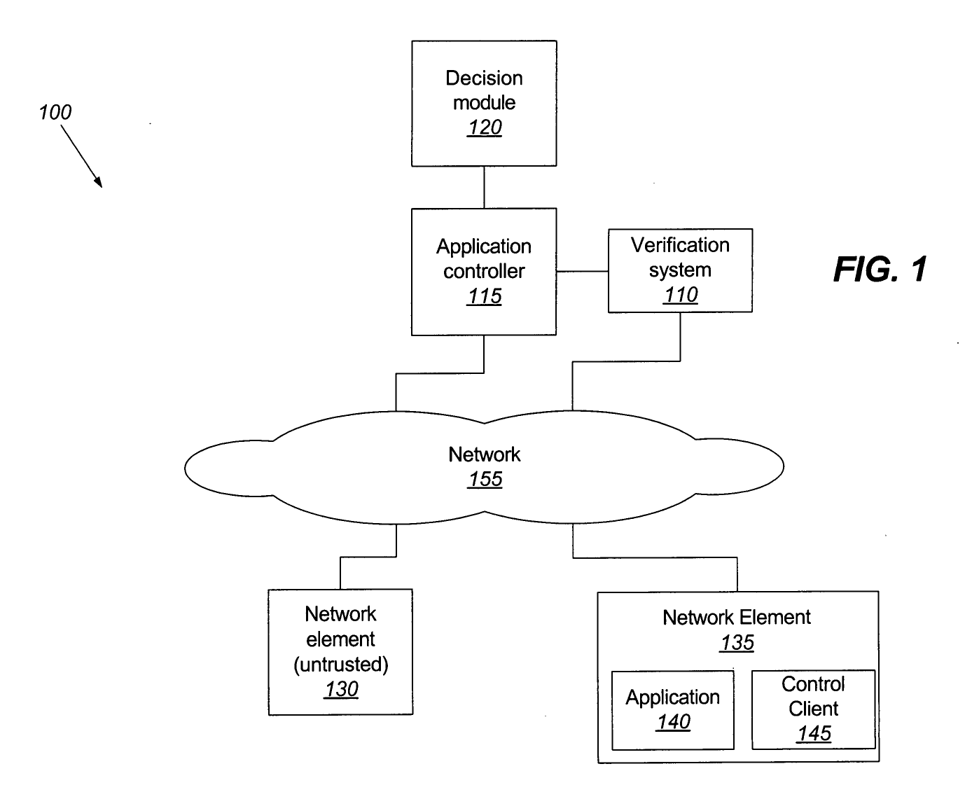

Referring now to FIG. 1, an exemplary network architecture 100 for managing application(s) on a vulnerable network element due to an untrustworthy network element by sending a command to an application to reduce the vulnerability of the network element, in accordance with some embodiments of the present invention, comprises a verification system 110, an application controller 115, a decision module 120, an untrusted network element 130, a network element 135, and a network 155 that are connected as shown. The network 155 may represent a global network, such as the Internet, or other publicly accessible network. The network 155 may also, however, represent a wide area network, a local area network, an Intranet, or other private network, which may not accessible by the general public. Furthermore, the network 155 may represent a combination of public and private networks or a virtual private network (VPN).

The verification system 110 may be configured to determine whether the network elements 130 and/or 135 are trustable or not, by, for example, determining a degree of trust for the network elements 130 and/or 135. This trust information may then be provided to the application controller 115. The verification system 110 may be embodied as described in, for example, U.S. patent application Ser. No. 10/880,249 entitled “Verification of Consumer Equipment Connected to Packet Networks Based on Hashing Values” (hereinafter '249 application), and U.S. patent application Ser. No. 10/886,169 entitled “Controlling Quality of Service and Access in a Packet Network Based on Levels of Trust for Consumer Equipment” (hereinafter '169 application), the disclosures of which are hereby incorporated herein by reference in their entireties.

As described in the '249 application and '169 application, the verification system 110 can determine a level of trust for the network elements 130 and/or 135 by generating first and second hash values based on data that are associated with the network elements 130 and/or 135, respectively. This data may represent any type of software and/or firmware, for example, associated with the network elements 130 and/or 135. If the hash values are not identical, then an evaluation may be made whether the network elements 130 and/or 135 can be trusted and/or what degree of trust may be assigned to the network elements 130 and/or 135.

As used herein, the term “network element” includes any device that is configured to communicate traffic, such as packet traffic, using the communication network 155. Accordingly, the network elements 130 and/or 135 may be, but are not limited to, a router, a gateway, a switching device, a cable modem, a digital subscriber line modem, a public switched telephone network modem, a wireless local area network modem, a wireless wide area network modem, a computer with a modem, a mobile terminal such as personal data assistant and/or cellular telephone with a modem. For network elements that communicate via the communication network 155 through a wireless interface, wireless protocols, such as, but not limited to, the following may be used: a cellular protocol (e.g., General Packet Radio System (GPRS), Enhanced Data Rates for Global Evolution (EDGE), Global System for Mobile Communications (GSM), code division multiple access (CDMA), wideband-CDMA, CDMA2000, and/or Universal Mobile Telecommunications System (UMTS)), a wireless local area network protocol (e.g., IEEE 802.11), a Bluetooth protocol, another RF communication protocol, and/or an optical communication protocol.

The application controller 115 may be configured to obtain trust and/or degree of trust information for network element(s) 130 and 135 from the verification system 110. In some embodiments, trust-relevant information from additional sources could alternately or additionally be considered. Such additional trust-relevant sources may include, but are not limited to, various network management systems, policy-based control systems, monitoring systems, including intrusion detection/protection systems, security scanning systems, third party security notification systems, outsourced security consulting/management services/systems, and/or security relevant information aggregation systems. For example, it may be determined that the network element 130 is untrustworthy. Furthermore, it may be determined that the network element 135 is trustworthy and/or that it is potentially vulnerable to attacks or other misuse originating from, associated with, and/or facilitated by a potentially compromised network element 130. The application controller 115 may include and/or have access to a database in which potential untrustable network elements are associated with potential vulnerable network elements from the communication network 155. Moreover, the database may include associations between potential controllable applications and the potential vulnerable network elements. Each of the controllable applications may have one or more controllable parameters that are associated therewith. The application controller 115 may determine one or more vulnerable network elements, e.g., network element 135 based on the associations in the database and, optionally, based on a degree of trust for the untrustable network element 130.

The decision module 120 may receive information on the untrustable network element 130 and the one or more vulnerable network elements from the application controller 115 and may apply defined rules thereto to select a command and/or a set of commands and/or a sequence of commands and/or an interactive script of commands that may be sent to an application 140, for example, on the vulnerable network element 135 so as to reduce the vulnerability of the network element 135 caused by the untrustworthiness of the network element 130. Thus, the selected command may be provided to the application controller 115, which identifies an appropriate set of parameter(s) for the command and then sends the command to the vulnerable network element 135 for execution by the application 140. In accordance with some embodiments of the present invention, the application 140 may translate the command to an appropriate form for execution on the vulnerable network element 135 or the vulnerable network element 135 may comprise a control client 145 that is used to process the command to invoke the application 140. The application controller 115 may monitor execution of the command by the application 140 by communicating with the vulnerable network element 135 to ensure that the command completed successfully. If one or more errors occur in executing the command, then alerts and/or alarms may be generated so that the command may be re-sent to the application 140 for a set number of re-tries and/or an administrator may manually intervene to take corrective action.

Although FIG. 1 illustrates an exemplary communication network, it will be understood that the present invention is not limited to such configurations, but is intended to encompass any configuration capable of carrying out the operations described herein.

The verification system 110, application controller 115, and/or decision module 120 may be embodied as one or more data processing systems that comprise, for example, input device(s), such as a keyboard or keypad, a display, and a memory that communicate with a processor. Such data processing system(s) may further include a storage system, a speaker, and an input/output (I/O) data port(s) that also communicate with the processor. The storage system may include removable and/or fixed media, such as floppy disks, ZIP drives, hard disks, or the like, as well as virtual storage, such as a RAMDISK. The I/O data port(s) may be used to transfer information between the data processing system(s) and another computer system or a network (e.g., the Internet). These components may be conventional components such as those used in many conventional computing devices, which may be configured to operate as described herein. Moreover, the functionality of the verification system 110, tunnel controller 115, and/or tunnel monitor 125 may be implemented as a single processor system, a multi-processor system, or even a network of stand-alone computer systems, in accordance with various embodiments of the present invention.

Computer program code for carrying out operations of the verification system 110, application controller 115, and/or decision module 120 may be written in a high-level programming language, such as C or C++, for development convenience. In addition, computer program code for carrying out operations of embodiments of the present invention may also be written in other programming languages, such as, but not limited to, interpreted languages. Some modules or routines may be written in assembly language or even micro-code to enhance performance and/or memory usage. It will be further appreciated that the functionality of any or all of the program modules may also be implemented using discrete hardware components, one or more application specific integrated circuits (ASICs), or a programmed digital signal processor or microcontroller.

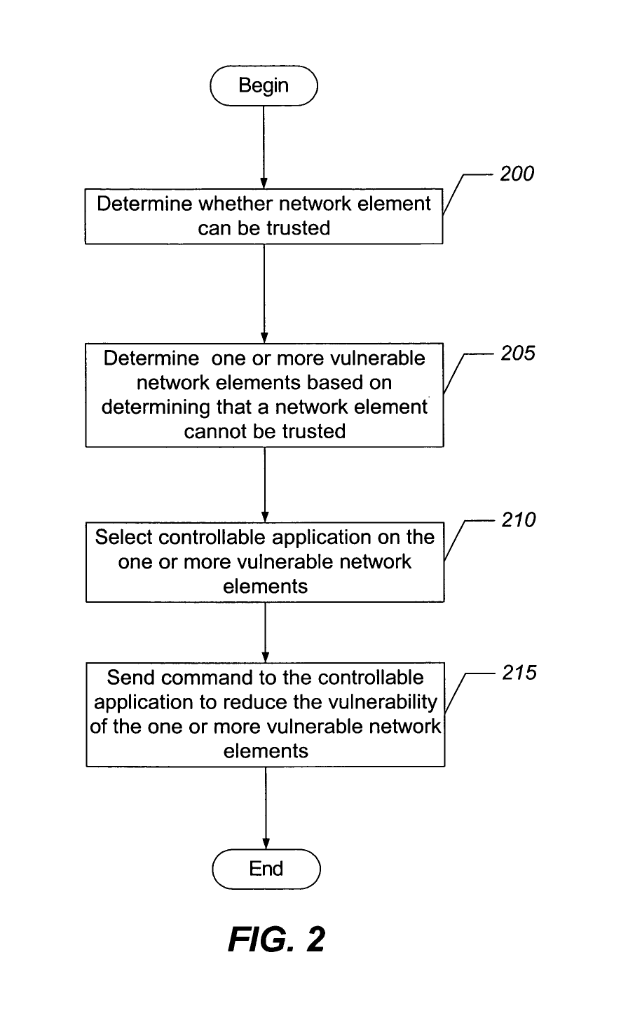

Exemplary operations for managing application(s) on a vulnerable network element due to an untrustworthy network element by sending a command to an application to reduce the vulnerability of the network element, in accordance with some embodiments of the present invention, will now be described with reference to FIGS. 2 and 1. Operations begin at block 200 where the verification system 110 determines whether a network element 130 can be trusted and/or to what degree that network element can be trusted. As discussed above and in detail in the '249 application and the '169 application, the verification system 110 may determine a degree of trust for a network element 130 by comparing hash values generated for data associated with the network element 130. Advantageously, the verification system 110 may be configured to automatically evaluate the network element 130 to determine a degree of trust for the network element 130. For example, the verification system 110 may generate a hash value for data associated with the network element 130 every time a timer expires, a packet count is reached, a particular event occurs at the network element 130, such as, for example, the start of a session initiation protocol (SIP) or Voice over Internet Protocol (VoIP) session, and/or a direct command to perform a hash operation on the data associated with the network element 130. For purposes of illustrating some embodiments of the present invention, it is assumed that the verification system 110 determines that the network element 130 is untrustworthy. In some embodiments, the verification system 110 determines that the network element 135 is trustworthy. As described above and further below, however, the network element 135 is determined by the application controller 115 to be vulnerable due to the untrustworthiness of the network element 130.

At block 205, the application controller 115 determines one or more network elements that are vulnerable in light of the untrustworthiness of the network element 130. In the example of FIG. 1, the network element 135 is determined to be vulnerable. As discussed above, the application controller 115 may determine that the network element 135 is vulnerable due to the untrustworthiness of the network element 130 by using the associations between potential untrustworthy network elements and potential vulnerable network elements in a database and, optionally, based on the degree of trust for the untrustable network element 130.

At block 210, the application controller 115 selects a controllable application, e.g., application 140, on the one or more determined vulnerable network elements, e.g., network element 135. In accordance with various embodiments of the present invention, the controllable application may be selected based on a degree of vulnerability associated with the one or more vulnerable network element(s), e.g., network element 135 and/or a priority associated with the controllable application. The controllable application may also be selected based on its ability to reduce the vulnerability and/or its lack of negative impact/consequences on normal operations of the network and its associated communications, applications, and services. These may in some cases be based on pre-configured predictions and related configured information. For example, a controllable application may be selected that has a relatively minor impact on the communication network 155 while still reducing the vulnerability of the network element 135. Also, results from previous uses of the selected application to reduce the vulnerability of the network element 135 may also be consulted.

At block 215, the application controller 115 sends a command to the selected controllable application, e.g., application 140 to reduce the vulnerability of the network element, e.g., network element 135. As discussed above, in accordance with some embodiments of the present invention, the decision module 120 may provide the command to send to the controllable application. The application controller 115 may identify an appropriate set of parameter(s) for the command. Various applications 140 and application parameters may be used in accordance with different embodiments of the present invention. Example applications may include, but are not limited to, a firewall application, an anti-virus application, a spy-ware (e.g., ad-ware) application, an operating system (e.g., Windows, Linux, Apple OS X, Palm OS, Symbian, VxWorks, etc.), an email client, an instant messaging client, a calendaring client, a peer-to-peer communication client (e.g., for file sharing), and/or a gaming application. The applications may include any software that can be controlled to affect communication and/or how the software interacts with other software on the same network element and/or other network elements. Example parameters may include, but are not limited to, an assignable network zone parameter, a traffic filtering parameter (e.g., source/destination addresses/ports, protocol type), a network service request parameter (e.g., requests for a specific Quality of Service and/or special routing); a data transport parameter (e.g., encryption/message integrity), a network element configuration parameter, a storage parameter (manner or location in which data is stored), a security parameter (e.g., authentication requirement and/or secure connection required), a file/data sharing parameter, an anti-virus parameter, an anti spy-ware parameter, a traffic exclusion parameter (e.g., exclusion from checking/blocking/filtering/quarantining/removal of traffic), a segregation of data and/or application parameter, a gaming parameter (resolution of game play, limits on updating, limits on players, exclusion of players), a bandwidth parameter, a privacy parameter (e.g., limits on calendar sharing), a file management parameter, a type management parameter, and/or a spam filtering parameter.

As discussed above, the application controller 115 may monitor execution of the command by the application 140 by communicating with the vulnerable network element 135 to ensure that the command completed successfully. If error(s) do occur, then the command may be retried one or more times and/or alerts and/or alarms may be generated to that an administrator may manually intervene.

The flowchart of FIG. 2 illustrates the architecture, functionality, and operations of some embodiments of methods, systems, and computer program products for managing application(s) on a vulnerable network element due to an untrustworthy network element by sending a command to an application to reduce the vulnerability of the network element. In this regard, each block represents a module, segment, or portion of code, which comprises one or more executable instructions for implementing the specified logical function(s). It should also be noted that in other implementations, the function(s) noted in the blocks may occur out of the order noted in FIG. 2. For example, two blocks shown in succession may, in fact, be executed substantially concurrently or the blocks may sometimes be executed in the reverse order, depending on the functionality involved.

Some embodiments of the present invention may be illustrated by way of example. Some time in the past, the verification system 110 checked the configuration of all of Melinda's home network PCs, including the gaming PC used by Melinda's son Tom, and recorded initial acceptable hash results for each. Later, the verification system 110 triggers a re-check of all of Melinda's PCs including Tom's PC to record recent hash results. Melinda then initiates a high-quality SIP videoconference with her business partner Pam and the verification system 110 either re-checks Melinda's PCs to generate a new hash results or accesses the most recent hash results and performs a compare with the initial acceptable hash results. The verification system 110 determines that Melinda's PC is okay, but a change has occurred in Tom's PC such that the level of trust for Tom's PC has been reduced, indicating that Tom's PC has potentially been compromised. The verification system 110 reports a degree of trust for Tom's PC as 2 out of 10 to the application controller 115.

The application controller 115 looks up Tom's PC to determine all of the other PCs or other entities in Melinda's home network that might be adversely affected by hacker activities on Tom's PC. The application controller 115 also looks up pertinent applications resident on Melinda's PC and determines that Melinda's PC, now initiating a videoconference, has a software firewall known to and registered with the application controller 115, e.g., the firewall has an identification stored in the application controller's database.

The application controller 115 checks the aspects of the firewall that can be controlled as well as the predicted effects/impacts of such control and sends control messages to the controller client software on Melinda's PC to place Tom's PC in the “Internet Zone” rather than the “Local Zone.” This may afford Melinda's PC the same strong protection from Tom's PC as it has from any attacker on the Internet. As needed, the application controller 115 may effect more detailed adjustments. Melinda's client software determines that the gateway changes were successful and reports this result back to the application controller 115. The application controller 115 may email Melinda to notify her of the change and also maintain a log of the foregoing operations.

Many variations and modifications can be made to the embodiments described herein without substantially departing from the principles of the present invention. All such variations and modifications are intended to be included herein within the scope of the present invention, as set forth in the following claims.

That which is claimed:

1. A method of operating a communication network, comprising:
determining whether a network element can be trusted;
determining at least one vulnerable network element based on a determination that the network element cannot be trusted;
selecting a controllable application on the at least one vulnerable network element; and
sending a command to the controllable application to reduce the vulnerability of the at least one vulnerable network element.

2. The method of claim 1, wherein determining whether a network element can be trusted, comprises:
generating a first hash value based on data associated with the network element;
generating a second hash value based on the data associated with the network element; and
comparing the first hash value with the second hash value to determine whether the network element can be trusted.

3. The method of claim 2, wherein generating the first hash value and generating the second hash value comprise:
generating the first hash value and the second hash value responsive to at least one of an expiration of a timer, a packet count associated with the network element, an event associated with then network element, and a hash generation command.

4. The method of claim 2, wherein comparing the first hash value with the second hash value to determine whether the network element can be trusted comprises comparing the first hash value with the second hash value to determine a degree of trust for the network element.

5. The method of claim 1, wherein determining the at least one vulnerable network element comprises:
determining the at least one vulnerable network element using rules that are based on network element trust information.

6. The method of claim 1, further comprising:
associating potential untrustable network elements with potential vulnerable network elements in the communication network;
associating potential controllable applications with the potential vulnerable network elements; and
identifying controllable application parameters that are associated with the controllable applications.

7. The method of claim 6, wherein determining the at least one vulnerable network element based on the determination that the network element cannot be trusted comprises:
selecting the at least one vulnerable network element from at least one potential vulnerable network element associated with the network element; and
wherein selecting the controllable application on the at least one vulnerable network element comprises:
selecting the controllable application as being associated with the at least one vulnerable network element.

8. The method of claim 7, wherein selecting the controllable application comprises:
selecting the controllable application based on a degree of vulnerability associated with the at least one vulnerable network element and/or a priority associated with the controllable application.

9. The method of claim 7, wherein the controllable application comprises:
a firewall application, an anti-virus application, a spy-ware application, an operating system, an email client, an instant messaging client, a calendaring client, a peer-to-peer communication client, and/or a gaming application.

10. The method of claim 6, wherein sending the command to the controllable application comprises:
selecting the command based on defined rules for reducing the vulnerability of the at least one vulnerable network element;
selecting at least one parameter identified as being associated with the controllable application; and
sending the command along with the selected at least one parameter to the controllable application.

11. The method of claim 6, wherein the at least one parameter comprises:
an assignable network zone parameter, a traffic filtering parameter, a network service request parameter; a data transport parameter, a network element configuration parameter, a storage parameter, a security parameter, a file/data sharing parameter, an anti-virus parameter, an anti spy-ware parameter, a traffic exclusion parameter, a segregation of data and/or application parameter, a gaming parameter, a bandwidth parameter, a privacy parameter, and/or a spam filtering parameter.

12. The method of claim 1, wherein sending the command to the controllable application comprises:
sending the command to the controllable application via a control client on the at least one vulnerable network element.

13. The method of claim 1, further comprising:
verifying that the at least one vulnerable network element can be trusted.

14. The method of claim 1, further comprising:
monitoring execution of the command on the at least one vulnerable network element; and
generating an alert if an error results from execution of the command.

15. A computer program product for operating a communication network, comprising:
a computer readable storage medium having computer readable program code embodied therein, the computer readable program code being configured to carry out the method of claim 1.

16. A communication network, comprising:
a verification system that is configured to determine whether a network element can be trusted; and
an application controller that is configured to determine at least one vulnerable network element based on a determination that the network element cannot be trusted, to select a controllable application on the at least one vulnerable network element, and to send a command to the controllable application to reduce the vulnerability of the at least one vulnerable network element.

17. The communication network of claim 16, wherein the application controller is further configured to associate potential untrustable network elements with potential vulnerable network elements in the communication network, to associate potential controllable applications with the potential vulnerable network elements, and to identify controllable application parameters that are associated with the controllable applications.

18. The communication network of claim 16, wherein the application controller is further configured to select the controllable application based on a degree of vulnerability associated with the at least one vulnerable network element and/or a priority associated with the controllable application.

19. The communication network of claim 16, further comprising:
a decision module connected to the application controller that is configured to select the command based on defined rules for reducing the vulnerability of the at least one vulnerable network element, and to select at least one parameter identified as being associated with the controllable application; and
wherein the application controller is further configured to send the command along with the selected at least one parameter to the controllable application.

20. The communication network of claim 16, wherein the application controller is further configured to monitor execution of the command on the at least one vulnerable network element, and to generate an alert if an error results from execution of the command.
